(19) United States
(12) Patent Application Publication
(10) Pub. No.: US 2019/0063569 A1
(43) Pub. Date: Feb. 28, 2019

(54) TURNBUCKLE

(71) Applicant: Caterpillar Inc., Peoria, IL (US)

(72) Inventors: Nathaniel K. Harshman, Sullivan, IL (US); David L. Cox, Monticello, IL (US)

(73) Assignee: Caterpillar Inc., Peoria, IL (US)

(21) Appl. No.: 15/687,572

(22) Filed: Aug. 28, 2017

(51) Int. Cl. F16H 25/20; F16H 57/04; E02F 3/84; E02F 3/76

(52) U.S. Cl. CPC F16H 25/2015; F16H 57/0497; F16H 2025/2093; E02F 3/844; E02F 3/765; F16H 57/0464

(57) ABSTRACT

A turnbuckle has a first turnbuckle end and a second turnbuckle end. The turnbuckle includes a first member coupled to the first turnbuckle end. The turnbuckle includes a sleeve having a first end and a second end. The sleeve receives the first member at the first end of the sleeve. The turnbuckle includes a gear mechanism coupled to the sleeve. The turnbuckle further includes an adjustment tool receiver provided on the gear mechanism. The adjustment tool receiver receives a common, non-custom driving tool to adjust a length of the turnbuckle between the first turnbuckle end and the second turnbuckle end.

### TECHNICAL FIELD

The present disclosure relates to a turnbuckle. More specifically, the present disclosure relates to an adjusting mechanism for a turnbuckle.

### BACKGROUND

A motor grader is a construction machine with a long blade which may be used to create a flat surface during a grading process. The motor grader has a longitudinal main frame which has a steerable wheel assembly at a front end thereof, an operator cab at a rear end of the machine, and a traction chassis for a motor and a power train behind the cab. A motor grader blade may be suspended from the main frame by means of a circle drawbar and a circle. The circle drawbar may have a front end connected to the front of the main frame by a ball and socket connection, while a rearward portion of the circle drawbar may be suspended from the main frame by hydraulic cylinders and piston means which permit the circle drawbar to swing either in a vertical plane or a horizontal plane about its front end.

Typically, the motor grader includes one or more hydraulic cylinders for positioning the blade. The hydraulic cylinders transfer force to the blade through ball and pin joints on the drawbar fastened through a mechanical fastener such as bolts, or a welding joint etc. However, various movements of the blade of the motor grader may not need to be adjusted very frequently. The hydraulic cylinders offer an expensive solution for adjusting the blade, provided that the adjustments are not needed very often.

Further, it is desirable to have ease of adjustments and/or maintenance that are somewhere lacking, generally in case of hydraulic systems, and for their replacement means by a turnbuckle. The turnbuckle may replace at least some (depending upon user preference) of the hydraulic linkage actuators with different advantages that would become more apparent as elaborated hereinafter. However, conventional turnbuckles, as employed for different purposes, still suffer from involvement of high efforts and/or custom tools for operations related to their adjustment. This makes the turnbuckle less appealing for a common user, devoid of such tools and skill sets for operation thereof.

For example, U.S. Pat. No. 6,247,540 (hereinafter referred to as '540 reference) discloses a blade pitch indicator removably secured to a linear actuator in the form of a turnbuckle. The turnbuckle includes two moveable yokes and a stationary threaded shaft, wherein rotation of the threaded shaft leads to extension or retraction of the yokes to change pitch position of bulldozer blade. However, the '540 reference does not provide means to easily operate the turnbuckle for adjusting the blade.

Thus, there is a need for an improved turnbuckle with ease of adjustment and economic benefits to overcome the problems described above.

### SUMMARY

In an aspect of the present disclosure, a turnbuckle is provided. The turnbuckle includes a first turnbuckle end and a second turnbuckle end. The turnbuckle includes a first member coupled to the first turnbuckle end. The turnbuckle includes a sleeve having a first end and a second end. The sleeve receives the first member at the first end. The turnbuckle includes a second turnbuckle end. The turnbuckle includes a gear mechanism coupled to the sleeve. The turnbuckle further includes an adjustment tool receiver provided on the gear mechanism. The adjustment tool receiver receives a driving tool to adjust a length of the turnbuckle between the first turnbuckle end and the second turnbuckle end.

In another aspect of the present disclosure, an implement for a machine is provided. The implement includes an implement coupled to a frame of the machine. The implement further includes a turnbuckle for adjusting the implement relative to the frame of the machine. The turnbuckle includes a first turnbuckle end and a second turnbuckle end. The turnbuckle includes a first member coupled to the first turnbuckle end. The turnbuckle includes a sleeve having a first end and a second end. The sleeve receives the first member at the first end. The turnbuckle includes a second turnbuckle end. The turnbuckle includes a gear mechanism coupled to the sleeve. The turnbuckle further includes an adjustment tool receiver provided on the gear mechanism. The adjustment tool receiver receives a driving tool to adjust a length of the turnbuckle between the first turnbuckle end and the second turnbuckle end.

In yet another aspect of the present disclosure, a machine is provided. The machine includes a power source, a frame, and an implement coupled to the frame. The machine further includes a turnbuckle for adjusting the implement relative to the frame of the machine. The turnbuckle includes a first turnbuckle end and a second turnbuckle end. The turnbuckle includes a first member coupled to the first turnbuckle end. The turnbuckle includes a sleeve having a first end and a second end. The sleeve receives the first member at the first end. The turnbuckle includes a second turnbuckle end. The turnbuckle includes a gear mechanism coupled to the sleeve. The turnbuckle further includes an adjustment tool receiver provided on the gear mechanism. The adjustment tool receiver receives a driving tool to adjust a length of the turnbuckle between the first turnbuckle end and the second turnbuckle end.

### BRIEF DESCRIPTION OF DRAWINGS

FIG. 1 illustrates an exemplary machine having an implement, in accordance with an aspect of the present disclosure;

FIG. 2 illustrates the implement of the machine having a turnbuckle, in accordance with an aspect of the present disclosure;

FIG. 3 illustrates the turnbuckle, in accordance with an aspect of the present disclosure; and

FIG. 4 illustrates the turnbuckle showing a gear mechanism, in accordance with an aspect of the present disclosure.

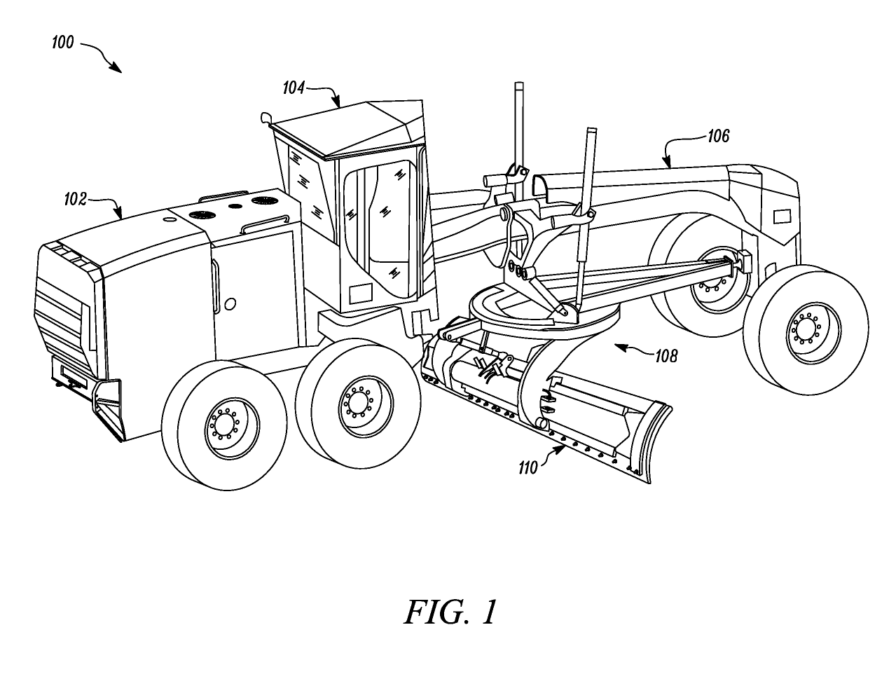

### DETAILED DESCRIPTION

Wherever possible, the same reference numbers will be used throughout the drawings to refer to same or like parts. FIG. 1 illustrates an exemplary machine 100 in accordance with an aspect of the present disclosure. Although, the machine 100 is illustrated as a motor grader, it should be contemplated that the machine 100 may be any other construction machine as well which may be suitable for application of the aspects of the present disclosure.

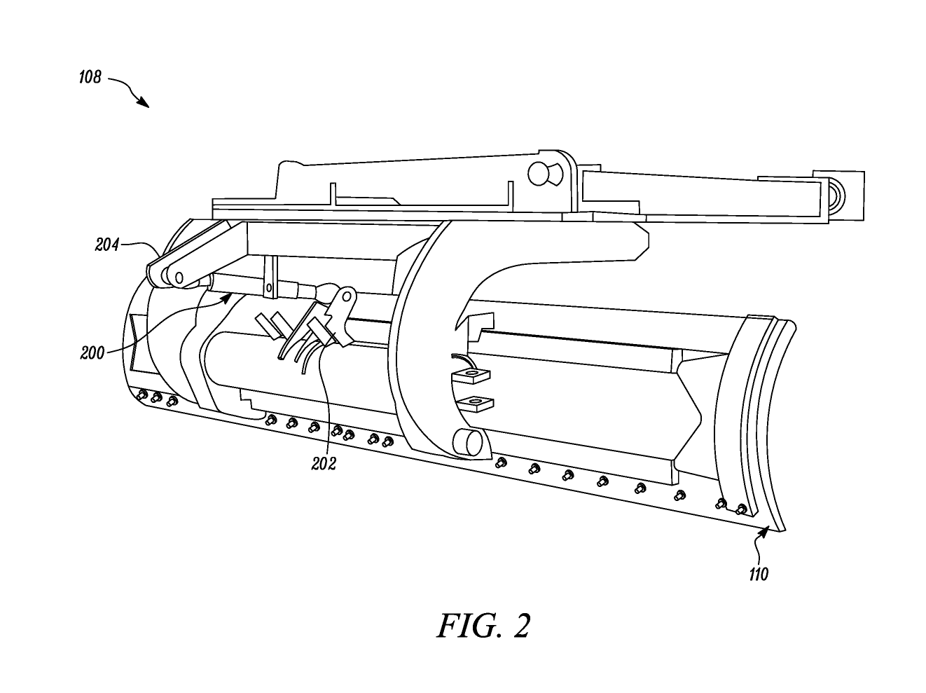

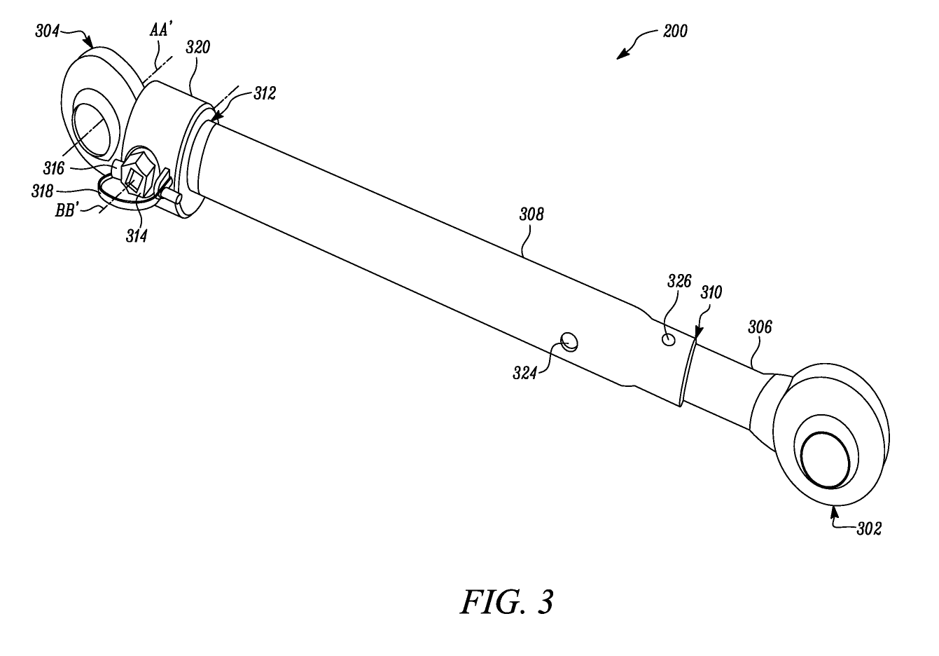

The machine 100 includes a power source 102 and an operator station 104. The machine 100 includes a frame 106, and an implement 108 coupled to the frame 106. The implement 108 includes a blade 110 adapted to impart a desired shape to a ground surface, or to perform any other such operation as per application requirements. The operator station 104 may include controls and/or user interface associated with various components of the machine 100 such as the power source 102, the implement 108 etc. The machine 100 includes three axles as illustrated herein, with the power source 102 and the operator station 104 present above the rear axles at a rear end of the machine 100 and a third axle at a front end of the machine 100, with the implement 108 (and essentially the blade 110) in between. The machine 100 further includes a turnbuckle 200 (best illustrated in FIGS. 2 and 3) for adjusting the blade 110 relative to the frame 106 of the machine 100.

Referring to FIG. 2, further structural details of the implement 108 are illustrated. The implement 108 is coupled to the frame 106 of the machine 100. The implement 108 includes the blade 110. The implement 108 further includes the turnbuckle 200 for adjusting the blade 110 relative to the frame 106 of the machine 100. The turnbuckle 200 is removably coupled to the blade 110 by means of a first bracket 202 and a second bracket 204 provided on the blade 110 of the implement 108. The turnbuckle 200 may be coupled to the frame 106 in any other suitable manner as well as per the need of the present disclosure. The present disclosure, in any manner, is not limited to means of coupling of the turnbuckle 200 to the frame 106. The implement 108 may include various other parts as well to couple the implement 108 to the frame 106 of the machine 100. However, these parts are not being discussed in detail as such parts do not concern the various aspects of the present disclosure.

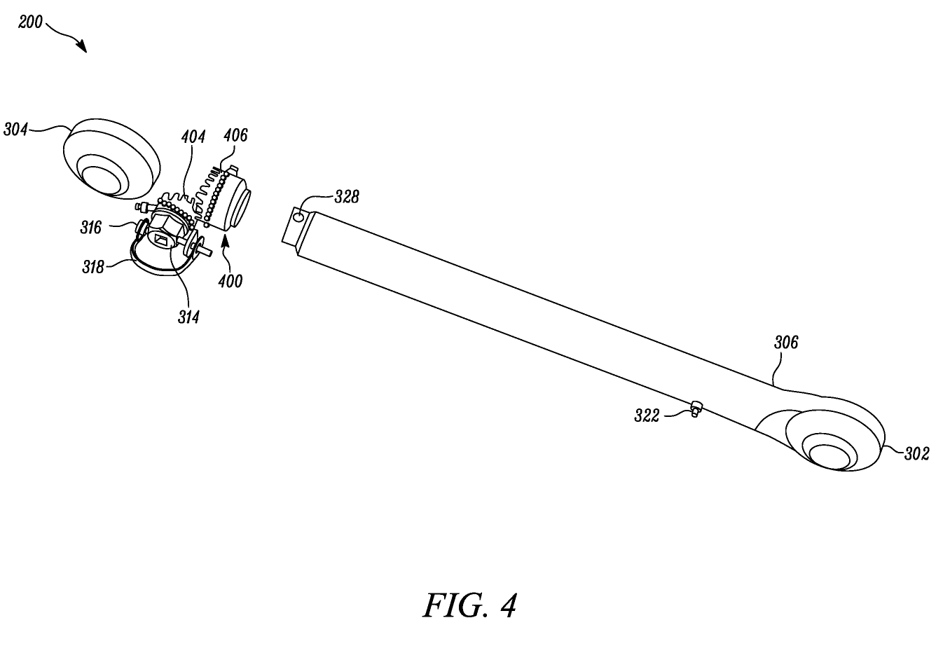

FIG. 3 shows further structural features of the turnbuckle 200. The turnbuckle 200 includes a first turnbuckle end 302 and a second turnbuckle end 304. The turnbuckle 200 further includes a first member 306 coupled to the first turnbuckle end 302. The turnbuckle 200 includes a sleeve 308 having a first end 310 and a second end 312. In the illustrated embodiment, the sleeve 308 has a generally hollow cylindrical structure. The sleeve 308 receives the first member 306 at the first end 310. The turnbuckle 200 includes a gear mechanism 400 (shown in FIG. 4) coupled to the sleeve 308. The turnbuckle 200 further includes an adjustment tool receiver 314 provided on the gear mechanism 400. The adjustment tool receiver 314 may receive a driving tool (not shown) to adjust a length of the turnbuckle 200 between the first turnbuckle end 302 and the second turnbuckle end 304. The driving tool may be a wrench or a ratchet. The driving tool may also be any other suitable driving tool which may suit the needs of the present disclosure.

The turnbuckle 200 further includes a locking pin 316 for preventing an unintended rotation of the adjustment tool receiver 314. The locking pin 316 may be provided with a stopper 318 to check an inadvertent use of the locking pin 316. While adjusting the length of the turnbuckle 200, the stopper 318 is removed to have access to the locking pin 316 which, in turn, is removed to engage a tool with the adjustment tool receiver 314. Herein, any common tool, as mentioned in accordance with implementation of the present disclosure, may be used due to square geometry of the adjustment tool receiver 314. The turnbuckle 200 further includes a collar 320 coupled to the second turnbuckle end 304. The collar 320 encloses the gear mechanism 400.

The sleeve 308 has internal threads on an inner surface while the first member 306 of the turnbuckle 200 has external threads on an external surface. The internal threads and the external threads are configured to mate with each other during assembly of the sleeve 308 over the first member 306 of the turnbuckle 200. It should be contemplated that sense of the internal threads of the sleeve 308 and the external threads will be the same, whether right-handed or left-handed threads, so as to ensure ease of assembly. In the illustrated embodiment, the first member 306 has a protrusion 322 (shown in FIG. 4) on the external surface, and the sleeve 308 includes a hole 324 such that the protrusion 322 prevents disengagement of the first member 306 towards the first end 310 of the sleeve 308 by engaging with the hole 324.

Further, the sleeve 308 includes a lubrication hole 326 for providing lubricant to the internal surface of the sleeve 308 as well as the external surface of the first member 306. In an embodiment, the sleeve 308 may consist of a grease zerk fitting to provide lubricant to threads of the mating parts, i.e. the sleeve 308 and the first member 306. Further, the lubrication hole 326 may also serve as a means for inspecting interference of the threads of the mating parts and for other purposes such as checking status of lubrication present therein.

The adjustment tool receiver 314 may receive a driving tool (for example a wrench, a ratchet etc.) to adjust a length of the turnbuckle 200 between the first turnbuckle end 302 and the second turnbuckle end 304, as elaborated earlier. From practical and implementation considerations, the adjustment tool receiver 314 is provided with a square internal geometry or a hexagonal external geometry of suitable size in accordance with tools commonly expected to be used therewith. But, geometries as known or implemented by one having ordinary knowledge in the art, other than square geometry of the present disclosure, such as, but not limited to, circular, trapezoidal, triangular among others have been well contemplated and therefore well within the scope of the present disclosure.

In an embodiment, presence of spherical ends (i.e. the first turnbuckle end 302 and the second turnbuckle end 304) of the turnbuckle 200 allows multiple degrees of freedom of pin bore axis relative to the linkage's longitudinal axis. However, it does not limit the scope of the present disclosure to prevent use of any other end configuration as would be apparent through various embodiments of the present disclosure.

In an embodiment, each degree of rotation applied to the adjustment tool receiver 314 may lead to a certain amount of extension or retraction, depending upon sense of the rotation, of the first member 306 relative to the sleeve 308. This varies the distance between the first turnbuckle end 302 and the second turnbuckle end 304. The driving tool may be appropriately used to adjust the length of the turnbuckle 200 as per application requirements. It should be contemplated that the second turnbuckle end 304 may be provided at any angular orientation relative to the adjustment tool receiver 314. Although the second turnbuckle end 304 is shown as having a rotational axis A-A′ parallel to a rotational axis B-B′ of the adjustment tool receiver 314, any other relative configuration of the two rotational axes is well within the scope of the present disclosure.

From safety considerations in implementation of the present disclosure, the adjustment tool receiver 314 includes a locking mechanism to restrict movement of the adjustment tool receiver 314. The locking mechanism has the locking pin 316 that locks the adjustment tool receiver 314 to check unintentional rotation and thereby extraction/retraction of the turnbuckle 200. From similar considerations, the first member 306 may consist of a safety stop 328 (shown in FIG. 4), which does not allow the first member 306 to leave a certain portion of the sleeve 308 and thereby restricts the first member 306 from coming out of the sleeve 308.

Referring to FIG. 4, the turnbuckle 200 is shown without the collar 320 and the sleeve 308. It should be contemplated that the collar 320 and the sleeve 308 are not shown only for the sake of illustrating internal structure of the turnbuckle 200. The collar 320 and the sleeve 308 remain integral parts of the turnbuckle 200. The turnbuckle 200 includes a gear mechanism 400 coupled to the adjustment tool receiver 314. As elaborated before, the adjustment tool receiver 314 may receive the driving tool to adjust the length of the turnbuckle 200 between the first turnbuckle end 302 and the second turnbuckle end 304.

The gear mechanism 400 includes a pair of gears having a first gear 404 and a second gear 406. In the illustrated embodiment, the first gear 404 and the second gear 406 are bevel gears. However, it should be contemplated that the gear mechanism 400 of the present disclosure may be any gear arrangement capable of transferring power between two-intersection axes. The axes may be at any suitable angle relative to each other which may be suitable as per the various aspects of the present disclosure. For instance, the gears as explained in context of the present disclosure are illustrated as bevel gears due to space and implementation benefits. However, any known or used gear arrangement for similar purposes can be readily used in implementation of the present disclosure without deviating from its scope.

The first gear 404 is coupled with the adjustment tool receiver 314 and the second gear 406 is coupled with the sleeve 308. The gear mechanism 400 takes input from the driving tool turning the adjustment tool receiver 314. The adjustment tool receiver 314 transfers the rotational motion through the first gear 404 and the second gear 406 to the sleeve 308. As the sleeve 308 and the first member 306 are threadably engaged to each other, the rotation of the gear mechanism 400 leads to liner motion of the sleeve 308 and the first member 306 relative to each other. Thus, the length of the turnbuckle 200 can be adjusted in this manner. Depending upon the extent/direction of adjustment of the turnbuckle 200, the adjustment tool receiver 314 and the gear mechanism 400 may serve the purpose henceforth served by conventional hydraulic link actuators with less effort and resources.

### INDUSTRIAL APPLICABILITY

The implement 108 of the present disclosure includes the blade 110 configured to be adjusted about vertical as well as horizontal planes for surface leveling purposes. This adjustment is done by the turnbuckle 200 through the gear mechanism 400 that is operable by simple tools, as compared to adjustments by controls and/or instrument cluster of the operator station 104 for conventional hydraulic actuators or by use of specialized tool in case of some conventional turnbuckle-like systems. Further, there is no need for additional connections with a hydraulic circuit of a machine for implement adjustments. The hydraulic circuit can be utilized in a more efficient manner. Hence, the turnbuckle 200 will not only provide a better solution than less frequently used costly systems such as the hydraulic cylinders but also allow use of simple, ubiquitous tools for its adjustments.

During adjustments of the turnbuckle 200, the adjustment tool receiver 314 configured with the gear mechanism 400 acts as the means for transferring the work done by the operator to effectuate telescoping of the first member 306 inside the sleeve 308. Notably, the adjustment tool receiver 314 includes a square geometry (in a preferred embodiment of size ½′ or ¾′ but other sizes are also contemplated and feasible) such that most common tools at disposal of a common operator could be employed at their advantage. In the embodiment, when the adjustment tool receiver 314 is an external hexagonal geometry, the size of the adjustment tool receiver may be selected as per the need of the present disclosure. The present disclosure, in any manner, is not limited to the size of the adjustment tool receiver.

The gear mechanism 400 of the present disclosure includes the pair of gears, preferably bevel gears. The rotational motion of the first and second gears 404, 406 is converted into linear motion of the first member 306 so as to provide telescoping slide inside the sleeve 308. Such linear motion allows adjustments of the turnbuckle 200 that otherwise are obtained by employing costly and high-maintenance prone hydraulic actuators. Further, enhanced features such as the safety stop 328 at one end of the first member 306 (preferably of diameter 38 mm) prevents over extension of the first member 306 from within the sleeve 308. Thus, the turnbuckle 200 provides a cost-effective and safe arrangement that serves as a potential candidate to replace conventional adjustment means.

There are several arrangements such as bulldozers, scrapers among other heavy machineries that can may utilize the turnbuckle 200 over hydraulic linkage actuators, and even in case of systems that do not involve blades and like implements. For instance, systems that involve infrequently used hydraulic actuators can utilize common tools with interface matching square geometry of the adjustment tool receiver 314 for adjusting the turnbuckle 200.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A turnbuckle comprising:
a first turnbuckle end;
a first member coupled to the first turnbuckle end;
a sleeve having a first end and a second end, wherein the sleeve is adapted to receive the first member at the first end;
a second turnbuckle end;
a gear mechanism coupled to the sleeve; and
an adjustment tool receiver provided on the gear mechanism, wherein the adjustment tool receiver is adapted to receive a driving tool to adjust a length of the turnbuckle between the first turnbuckle end and the second turnbuckle end.

2. The turnbuckle of claim 1, wherein the adjustment tool receiver has a square geometry.

3. The turnbuckle of claim 1, wherein the driving tool is a wrench.

4. The turnbuckle of claim 1, wherein the adjustment tool receiver further includes a locking pin for preventing unintended rotation of the gear mechanism.

5. The turnbuckle of claim 1, further comprising a collar coupled to the second turnbuckle end, wherein the collar encloses the gear mechanism.

6. The turnbuckle of claim 1, wherein the first member has a protrusion on an external surface, and the sleeve includes a hole such that the protrusion prevents disengagement of the first member towards the first end of the sleeve by engaging with the hole.

7. The turnbuckle of claim 1, wherein the sleeve further includes a lubrication hole for providing lubricant to an internal surface of the sleeve and an external surface of the first member.

8. An implement for a machine, the implement comprising:
an implement coupled to a frame of the machine; and
a turnbuckle for adjusting the implement relative to the frame of the machine, the turnbuckle including:
a first turnbuckle end;
a first member coupled to the first turnbuckle end;
a sleeve having a first end and a second end, wherein the sleeve is adapted to receive the first member at the first end;
a second turnbuckle end;
a gear mechanism coupled to the sleeve; and
an adjustment tool receiver provided on the gear mechanism, wherein the adjustment tool receiver is adapted to receive a driving tool to adjust a length of the turnbuckle between the first turnbuckle end and the second turnbuckle end.

9. The implement of claim 8, wherein the adjustment tool receiver has a square geometry.

10. The implement of claim 8, wherein the driving tool is a wrench.

11. The implement of claim 8, wherein the adjustment tool receiver further includes a locking pin for preventing unintended rotation of the gear mechanism.

12. The implement of claim 8, further comprising a collar coupled to the second turnbuckle end, wherein the collar encloses the gear mechanism.

13. The implement of claim 8 wherein the first member has a protrusion on an external surface, and the sleeve includes a hole such that the protrusion prevents disengagement of the first member towards the first end of the sleeve by engaging with the hole.

14. The implement of claim 8, wherein the sleeve further includes a lubrication hole for providing lubricant to an internal surface of the sleeve and an external surface of the first member.

15. A machine comprising:
a power source;
a frame;
an implement coupled to the frame; and
a turnbuckle for adjusting the implement relative to the frame of the machine, the turnbuckle including:
a first turnbuckle end;
a first member coupled to the first turnbuckle end;
a sleeve having a first end and a second end, wherein the sleeve is adapted to receive the first member at the first end;
a second turnbuckle end;
a gear mechanism coupled to the sleeve; and
an adjustment tool receiver provided on the gear mechanism, wherein the adjustment tool receiver is adapted to receive a driving tool to adjust a length of the turnbuckle between the first turnbuckle end and the second turnbuckle end.

16. The machine of claim 15, wherein the adjustment tool receiver has a square geometry.

17. The machine of claim 15, wherein the driving tool is a wrench.

18. The machine of claim 15, wherein the adjustment tool receiver further includes a locking pin for preventing unintended rotation of the gear mechanism.

19. The machine of claim 15, further comprising a collar coupled to the second turnbuckle end, wherein the collar encloses the gear mechanism.

20. The machine of claim 15, wherein the first member has a protrusion on an external surface, and the sleeve includes a hole such that the protrusion prevents disengagement of the first member towards the first end of the sleeve by engaging with the hole.
